(19) United States
(12) Patent Application Publication
(10) Pub. No.: US 2021/0192340 A1
(43) Pub. Date: Jun. 24, 2021

(54) MACHINE LEARNING BASED IMAGING METHOD OF DETERMINING AUTHENTICITY OF A CONSUMER GOOD

(71) Applicant: The Procter & Gamble Company, Cincinnati, OH (US)

(72) Inventors: Jonathan Richard Stonehouse, Windlesham (GB); Boguslaw Obara, Bowburn (GB)

(21) Appl. No.: 16/953,387

(22) Filed: Nov. 20, 2020

Related U.S. Application Data
(60) Provisional application No. 62/951,023, filed on Dec. 20, 2019.

(51) Int. Cl. G06N 3/08; G06N 3/04; G06Q 30/00

(52) U.S. Cl. CPC G06N 3/08; G06Q 30/0185; G06N 3/04

(57) ABSTRACT

An economical and accurate machine learning based imaging method of classifying a consumer good as authentic is provided. The machine learning based imaging method leverages machine learning and the use of steganographic features on the authentic consumer good.

### FIELD OF THE INVENTION

The present invention relates to an economical way of determining the authenticity of a consumer good.

### BACKGROUND OF THE INVENTION

Counterfeiting is a worldwide problem. It economically harms consumers and manufacturers and can pose safety concerns to consumers. Overt technologies such as holograms, and covert technologies like taggants have been proposed. But these technologies are expensive to implement and/or require specialized equipment and/or specialized skills/training. This is particularly problematic for fast moving consumer goods that generally have low margins (e.g., laundry detergent, shampoo, body wash, diapers, etc.) and thus require solutions that are cost effective. Moreover, end-users (i.e., consumers) want a solution that is easy to implement/understand, while manufacturers want one that is inexpensive and reasonably accurate.

One proposed approach to authenticating products is based on imaging microscopic variations and the use of machine learning. However, this approach may have certain disadvantages such as the potential need for specialized equipment to capture images on a microscope scale (e.g., analyzing microscopic variations at the 10 micrometer range), the need to capture a plurality of images from different aspects of the subject consumer good (thereby requiring significant effort, that is, a high barrier to adoption, by the end-user), model complexity given the need to identify features on a microscopic scale (thereby reducing processing speed/response time).

Accordingly, there is a need for a cost-effective solution that provides reasonable accuracy and leverages consumer ubiquitous equipment and technology such as a smart phone having a camera.

### SUMMARY OF THE INVENTION

The present invention is based on the surprising discovery that using steganographic features in product specification(s) coupled with machine learning can result in a low cost, user friendly, and accurate counterfeit detecting method/system. Based upon unpublished internal benchmarking studies comparing with sticker/tags with the present invention through the lens of consumer adoption, the present invention provides a more cost-effective approach to stopping counterfeits with a better return on investment for manufacturers.

Furthermore, the present invention is based, at least in part, on the surprising discovery that camera bias can have significant effect on modeling training. Accordingly, the present invention is based on addressing this bias to have higher predictive accuracy from the machine learning models for the methods herein described. In other words, the model learns that is important to learn to determine whether a subject consumer good is authentic or non-authentic, and not bias that can otherwise be introduced by the camera type.

One aspect of the invention provides a method for classifying whether a subject consumer good is authentic or non-authentic. The method steps comprise: (a) obtaining an image of the subject consumer good comprising a subject product specification; (b) inputting the obtained image into a model; and (c) outputting output from the model classifying the inputted image of the subject consumer good as authentic or non-authentic. The model is configured to classify the obtained image as authentic or non-authentic. The model is constructed by a machine learning classifier. The machine learning classifier is trained by a training dataset. The training dataset comprises: (i) extracted images, from a plurality of different camera types, authentic product comprising an authentic product specification, wherein said authentic product specification comprises at least one steganographic feature having a length greater than 0.01 mm; and (ii) an associated class definition based on said steganographic feature (of said authentic product specification of said authentic product).

Another aspect of the invention provides for a method for classifying whether a subject consumer good is authentic or non-authentic. The method steps comprise: (a) obtaining an image of the subject consumer good comprising a subject product specification; (b) inputting the obtained image into a model; and (d) outputting output from the model classifying the inputted image of the subject consumer good as authentic or non-authentic. The model is configured to classify the obtained image as authentic or non-authentic. The model is constructed by a machine learning classifier. The machine learning classifier is trained by a training dataset. The training dataset comprises: (i) extracted images, from a plurality of different camera types, of an authentic product comprising an authentic product specification, wherein said authentic product specification comprises Manufacturing Line Variable Printing Code (defined below); (ii) extracted images, from said plurality of different camera types, of non-authentic product comprising a non-authentic product specification, wherein the non-authentic product specification is different from said at least one steganographic feature; and (iii) an associated class definition based on said Manufacturing Line Variable Printing Code (of said authentic product specification of said authentic product).

In another aspect of the invention, a tangible, non-transitory computer-readable medium is disclosed storing instructions for imaging and classifying whether one or more physical and subject consumer goods are authentic or non-authentic. The instructions, when executed by one or more processors, cause the one or more processors to: a) obtain an image of a subject consumer good comprising a subject product specification; b) input the obtained image into a model, wherein the model is configured to classify the obtained image as authentic or non-authentic, wherein the model is constructed by a machine learning classifier, wherein the machine learning classifier is trained by a training dataset, wherein the training dataset comprises: (i) extracted images, from a plurality of different camera types, of an authentic product comprising an authentic product specification comparable with the subject product specification, wherein the authentic product specification comprises at least one steganographic feature having a length greater than 0.01 mm; and (ii) an associated class definition based on the steganographic feature; and c) output a classification output from the model indicating a likelihood that the image of the subject consumer good is authentic or non-authentic.

In a still further aspect of the invention, a machine learning based imaging system is configured to image and classify whether one or more physical and subject consumer goods are authentic or non-authentic. The machine learning based imaging system comprises: a server comprising a processor and a memory, the memory storing a model; and a software application (app) configured to execute on a mobile device comprising a mobile processor and a mobile memory, the software app communicatively coupled to the server via a computer network, wherein the server comprises computing instructions configured for execution on the processor, and that when executed by the processor causes the processor to: a) obtain an image of a subject consumer good comprising a subject product specification, the image captured by the mobile device; b) input the obtained image into the model, wherein the model is configured to classify the obtained image as authentic or non-authentic, wherein the model is constructed by a machine learning classifier, wherein the machine learning classifier is trained by a training dataset, wherein the training dataset comprises: (i) extracted images, from a plurality of different camera types, of an authentic product comprising an authentic product specification comparable with the subject product specification, wherein the authentic product specification comprises at least one steganographic feature having a length greater than 0.01 mm; and (ii) an associated class definition based on the steganographic feature; c) output a classification output from the model indicating a likelihood that the image of the subject consumer good is authentic or non-authentic; and d) transfer the classification output to the software application for display or use by the mobile device.

An advantage is reducing camera bias that may otherwise effect model training. The model is consequently more robust.

A potential advantage is to reduce model complexity and thus response time by providing training the machine learning classifier on a scale larger than 10 micrometers.

Another potential is a method based on machine learning is more robust, and thus high accuracy of counterfeit detection, compared to a method based on comparing the subject consumer good to a template, which inherently will have smaller subset of information.

Another potential advantage is that anyone along the distribution chain to determine whether a subject consumer product is authentic or not provides for multiple points along the chain to police and stop counterfeiters before economic harm or product safety is inflicted by the counterfeits.

Another advantage is a cost that is cheaper, easier to implement and more adaptable than the use of QR code scannable system which requires generating, finding space to add a QR code on the product, and data basing the QR code.

In accordance with the above, and with the disclosure herein, the present disclosure includes improvements in computer functionality or improvements to other technologies at least because the claims recite that, e.g., that a mobile device and/or server is improved by execution or implementation of a trained model which increases, or otherwise provides, the mobile device's and/or server's functionality to output classification(s) from the model indicating a likelihood that an image of a physical subject consumer good is authentic or non-authentic. That is, the present disclosure describes improvements in the functioning of the computer itself or “any other technology or technical field” because a mobile device and/or server can implement an efficient model (e.g., machine learning model) that is itself a reduced computer model compared to the various images and data used to train the model. The model allows the mobile device and/or server to use fewer processing and/or memory resources. This improves over the prior art at least because conventional computing systems relied on manual detection and/or human vision, of large numbers of stored images, in order to authenticate goods as depicted in computer images.

In addition, the present disclosure includes effecting a transformation or reduction of a particular article to a different state or thing, e.g., transforming various images of a subject consumer good, as taken by various and different camera devices, into a model (e.g., machine learning model) that can output a classification output from the model indicating a likelihood that the image of the subject consumer good is authentic or non-authentic.

Still further, the present disclosure includes specific features other than what is well-understood, routine, conventional activity in the field, or adding unconventional steps that confine the claim to a particular useful application, e.g., machine learning based imaging systems and methods for imaging and classifying whether one or more physical and subject consumer goods are authentic or non-authentic,

These and other features, aspects, and advantages of the present invention will become evident to those skilled in the art from the detailed description which follows.

### BRIEF DESCRIPTION OF THE DRAWINGS

The embodiments set forth in the drawings are illustrative in nature and not intended to limit the invention defined by the claims. The following detailed description of the illustrative embodiments can be understood when read in conjunction with the following drawings, where like structure is indicated with like reference numerals and in which:

FIG. 1A is a flow diagram of a method of the present invention with specific mention to a training data set;

FIG. 1B is a flow diagram further detailing the training data set included in FIG. 1A;

FIG. 1C illustrates an example user interface as rendered on a display screen of a digital image obtaining camera device;

FIG. 1D illustrates an example machine learning based imaging system configured to image and classify whether one or more physical and subject consumer goods are authentic or non-authentic;

FIG. 2A is an example of an alphanumeric text in the form of the word “Hello”;

FIGS. 2B to 2H are examples of steganographic features deliberated provided to the alphanumeric text of FIG. 2A;

FIG. 3 is an example of Manufacturing Line Variable Printing Code (that may or may not have a steganographic feature);

FIG. 4 is a first example of a non-alphanumeric character of the Code from FIG. 3; and

FIG. 5 is a second example of a non-alphanumeric character of the Code from FIG. 3.

FIGS. 6A and 6B is a pair of images for a training set taken by two different camera types.

FIG. 7 shows examples of augmented training images with basic geometric and color distortions.

FIG. 8 shows a pretrained model ResNet34 not only achieves high accuracy at camera classification but does so very quickly.

FIG. 9 is a bar graph of distribution of responses for a model trained on the Disjoint training set, on which for authentic images are iPhone or Samsung and non-authentic images are Huawei or Redmi.

FIG. 10 is a bar graph of distribution of response for a model trained on the Partial training set, in which only iPhone or Samsung images are present, with no camera/label correlation.

FIG. 11 is a binary segmented image of a batchcode.

### DETAILED DESCRIPTION OF THE INVENTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

### Definitions

The term “comprising” as used herein means that steps and ingredients other than those specifically mentioned can be added. This term encompasses the terms “consisting of” and “consisting essentially of.” The compositions of the present invention can comprise, consist of, and consist essentially of the essential elements and limitations of the invention described herein, as well as any of the additional or optional ingredients, components, steps, or limitations described herein.

As used herein, the articles including “a” and “an” when used in a claim, are understood to mean one or more of what is claimed or described.

As used herein, the words “preferred”, “preferably” and variants refer to embodiments of the invention that afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

A method for classifying whether a subject consumer good is authentic or non-authentic is provided.

### Model

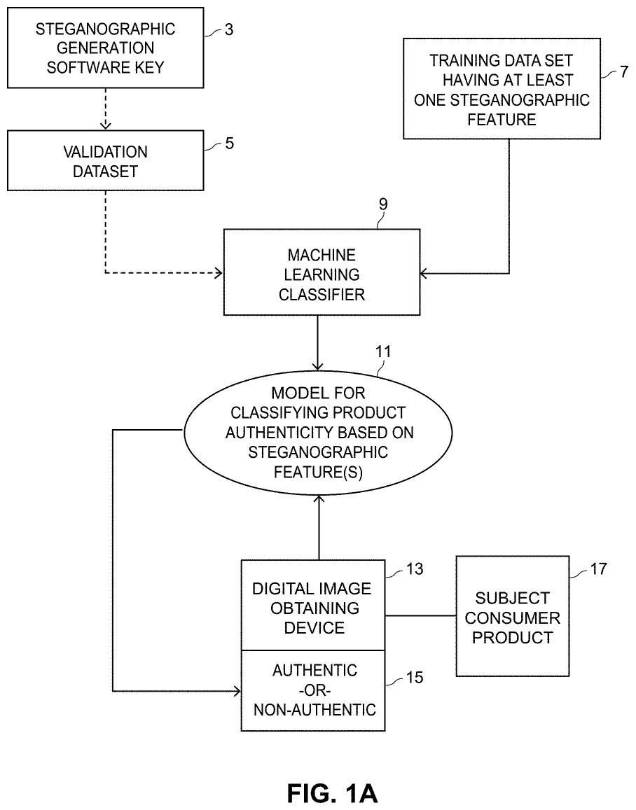

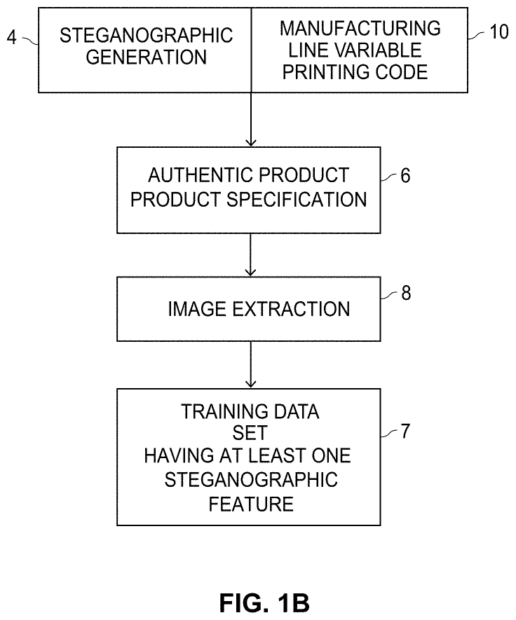

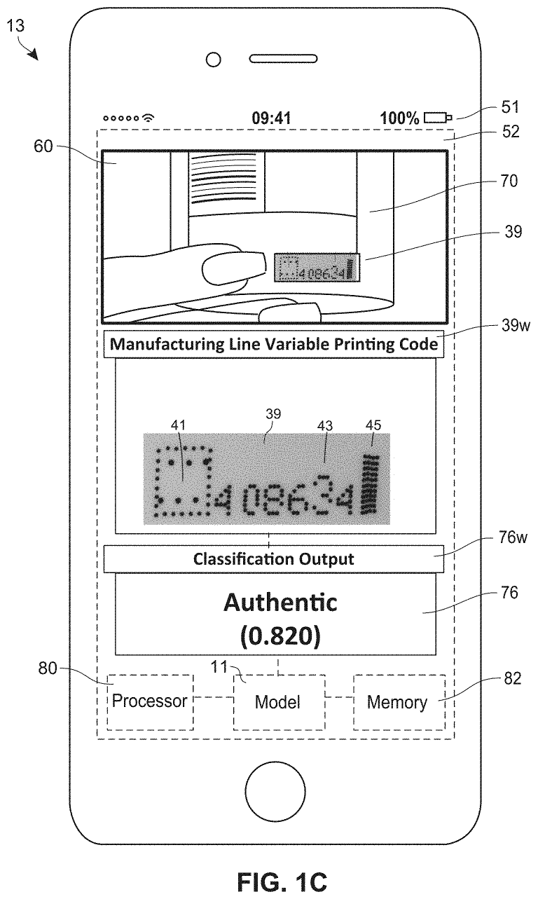

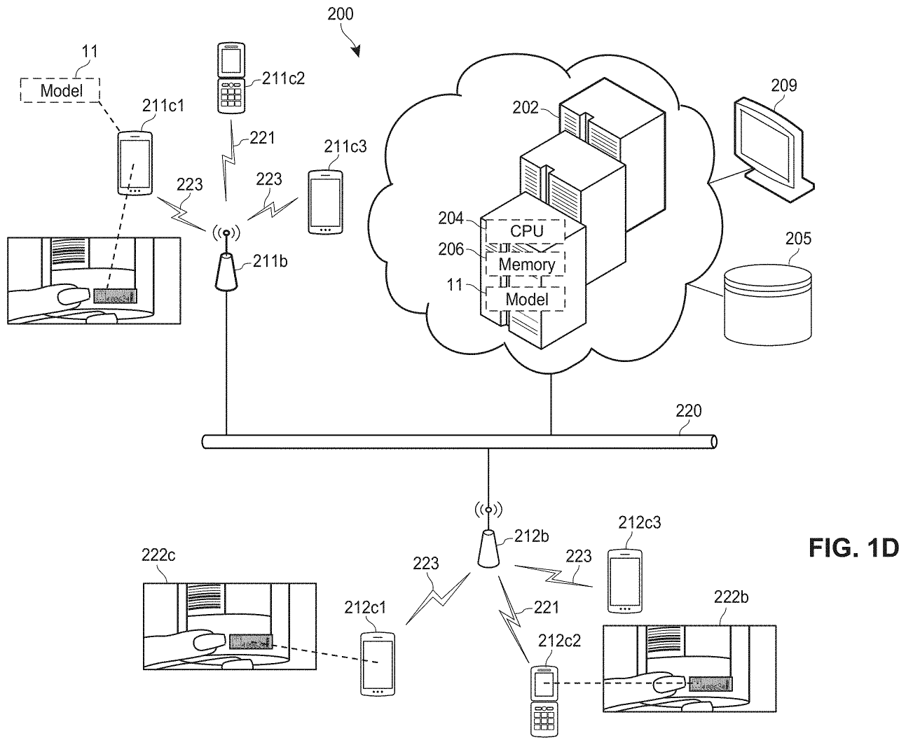

Referencing FIG. 1A, a model (11) is provided that is configured to classify an image of a subject product (17) comprising a specification as authentic or non-authentic (15). The model (11) is constructed by a machine learning classifier (9). In various embodiments, model (11) comprises a machine learning model that may be trained using a supervised or unsupervised machine learning program or algorithm. The machine learning program or algorithm may employ a neural network, which may be a convolutional neural network, a deep learning neural network, or a combined learning module or program that learns in two or more features or feature datasets in particular area(s) of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques. Machine learning may involve identifying and recognizing patterns in existing data (such as steganographic characters, text, images, markings, or otherwise visuals located, e.g., on a consumer product) in order to facilitate making predictions for subsequent data (to predict or classifying whether a consumer product is authentic or is not authentic).

Machine learning model(s), such as, e.g., model (11), may be created and trained based upon example (e.g., “training data,”) inputs or data (which may be termed “features” and “labels”) in order to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based on the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated. The disclosures herein may use one or both of such supervised or unsupervised machine learning techniques.

With reference to FIGS. 1A and 1B, the constructed model (11) is capable of image classification. That is, a digital image (obtained from a digital image obtaining camera device (13), e.g., a computing device, such as a mobile device or mobile phone) of a subject consumer product (17) and its specification is inputted into the constructed model (11) which outputs at least one classification that best describes the digital image. Specifically, the at least one classification classifies whether the subject consumer product (17) is authentic or non-authentic (15).

FIG. 1C illustrates an example user interface (52) as rendered on a display screen (51) of a digital image obtaining camera device (13), e.g., a computing device, such as a mobile device or mobile phone, in accordance with various embodiments disclosed herein. For example, as shown in the example of FIG. 1C, user interface (52) may be implemented or rendered via an application (app) executing on image obtaining camera device (13). Digital image obtaining camera device (13) may comprise a processor (80) and a memory (82) that may be used to execute, implement, and/or store model (11).

As shown in the example of FIG. 1C, user interface (52) may be implemented or rendered via a native app executing on image obtaining camera device (13). In the example of FIG. 1C, image obtaining camera device (13) is a mobile deice, or mobile phone, as described herein, e.g., where digital image obtaining camera device (13) is illustrated as an APPLE iPhone that implements the APPLE iOS operating system and has display screen (51). Digital image obtaining camera device (13) may execute one or more native applications (“app” or “apps”) on its operating system. Such native apps may be implemented or coded (e.g., as computing instructions) in a computing language (e.g., SWIFT) executable by the mobile device operating system (e.g., APPLE iOS) by processor (80) of image obtaining camera device (13). In other embodiments, a native app may be implemented or coded (e.g., as computing instructions) in other computing languages (e.g., Java) executable by the image obtaining camera device (13) operating system (e.g., GOOGLE ANDROID by processor (80) of image obtaining camera device (13). Other such operating systems, and related image obtaining camera devices (13), each executing or implementing its own native application platform, are contemplated herein.

Additionally, or alternatively, user interface (52) may be implemented or rendered via a web interface, such as via a web browser application, e.g., Safari and/or Google Chrome app(s), or other such web browser or the like.

As shown in the example of FIG. 1C, user interface (52) comprises an image or graphical representation, e.g., image (60), depicting a consumer good (70) (e.g., a bottle-based product, e.g., a shampoo bottle) having a subject product specification, e.g., a Manufacturing Line Variable Printing Code (39), as printed or otherwise affixed on consumer good (70). Image (60) may have be obtained or captured by a camera (not shown) of the image obtaining camera device (13). In the example of FIG. 1C, the subject product specification, e.g., a Manufacturing Line Variable Printing Code (39), is displayed on user interface (52) in window (39w). Further, in the example of FIG. 1C, the Manufacturing Line Variable Printing Code (39) comprises a patterned box made from dots (41), alphanumeric text (e.g., number “3” (43)), and a dotted column (45), each as further described herein. Model (11), which may be implemented on, or executed by, processor (80) and/or stored on memory (82) may output or display a classification output from the model indicating a likelihood (e.g., 0.820 or 82 percent (%)) that the image of the subject consumer good is authentic or non-authentic. For example, in the example of FIG. 1C, the Manufacturing Line Variable Printing Code (39), is determined or classified by model (11) as “Authentic” (76) at a likelihood of 82 percent (%). Such output may be displayed in window (76w) of user interface (52). In other embodiments, for example as described herein for FIG. 1D, model (11) may be implemented on a server, where the output classification is transferred to image obtaining camera device (13) via a computer network and then displayed in window (76w) of user interface (52).

In various embodiments model (11) may be implemented on, or executed by, processor (80). The model (11) is constructed by a machine learning classifier (9). One or more such machine learning classifiers (9) can be used. The machine learning classifier (9) is trained by a training dataset (9). The training dataset is further described in FIG. 1B. Preferably the machine learning classifier (9) is further validated and improved by a validating dataset (5) and/or a testing dataset (not shown). Non-limiting examples of one or more machine learning classifiers (9) include anomaly detection systems/techniques and the like. Preferably the machine learning classifier (9) is a neural network, more preferably a convolutional neural network (“CNN”). A non-limiting example of a CNN is a Wasserstein Deep Convolutional Generative Adversarial Network. CNN is a specialized kind of neural network for processing data in grid-like topology. The network uses a mathematical operation of convolution to extract a set of features from the input image. The first layer of the CNN learns to recognize simple patterns, middle layers more complex patterns, while later layers locate and recognize major objects in the image (e.g., brand name).

The first layer of a CNN is a convolutional layer. The input into the CNN is an array of pixel values (e.g., height, width, intensity) from an image. More than one convolution layer is used. A nonlinear layer (or activation layer) is typically used after each convolutional layer. To this end, a rectified linear units (ReLU) layer is preferred. Pooling layers (also known as a down sampling layer) may be included, preferably after each ReLU layer. These pooling layer(s) reduce the spatial dimension of the input volume, which can help with computation cost and help to control overfitting. Overfitting means the model is overly tuned to the training dataset such that it is not able to generalize well for the optional validating and/or testing datasets. One approach to address overfitting is by way of dropout. A dropout technique is essentially a regularization method used to prevent over-fitting while training neural nets. Preferably there is more drop out of the deeper layers, so the higher frequency features are learned better. A fully connected layer is at the end of the CNN. This layer takes input (from the immediately preceding layer) and outputs an n dimensional vector where n is the number of classes that the model must choose from. In other words, the machine learning classifier preferably comprises an n-layer CNN which learns distinguishing features based on the depth of the n-layers. Preferably the machine learning classifier comprises assembling n-layered CNN and classifying the image as a combination of output probabilities of each of the n-layered convolutional networks. For example, the n-layered CNN can be a 4-layer, 6-layer, 8-layer, 12-layer, or 16-layer network.

The method comprises the step of determining a camera type of the camera that provided the image of the subject consumer good (comprising a subject product specification). Many techniques have been developed to trace digital photos back to their camera of origin, primarily by the digital forensics' community. Most of these methods revolve around extracting a unique sensor noise fingerprint from the image and matching it against the reference patterns of known cameras. Since sensor noise is a complex phenomenon with multiple sources (e.g. photonic noise, lens imperfections, dust particles, dark currents, non-uniform pixel sensitivity), there are many ways of doing this. Other techniques include identifying cameras by their unique patterns of dead and hot pixels, however not all cameras have dead pixels, and some remove them via post-processing showing that radial lens distortion is a useful feature for identifying cameras. Unlike noise-based approaches, lens distortion can identify models of camera but not individuals. Recognizes cameras by dark current noise, which is a small, constant signal emitted by a CCD, varying randomly from pixel to pixel. Although every digital camera has such a noise pattern and it will always be unique, it can only be acquired from dark frames where no light strikes the sensor, and is only a small component of sensor noise propose a more robust method that exploits the non-uniform sensitivity to light among sensor pixels, which is a much stronger component and does not require dark frames to measure. CNN-based methods have shown great potential in digital camera identification from images using standard supervised training. See e.g., Amel Tuama, et al., “Camera model identification with the use of deep convolutional neural networks,” in IEEE International Workshop on Information Forensics and Security, 2016, pp. 1-6; Luca Bondi, et al., “A preliminary study on convolutional neural networks for camera model identification,” Electronic Imaging, no. 7, pp. 67-76, 2017; Ye Yao, et al., “Distinguishing computer-generated graphics from natural images based on sensor pattern noise and deep learning,” Sensors, vol. 18, no. 4, pp. 1296, 2018. Each of these references are incorporated by reference herein.

The machine learning classifier is trained by a training dataset. In turn and referencing FIG. 1B, the training dataset (7) comprises extracted image(s) of an authentic product (8) comprising an authentic product specification (6), wherein the authentic product specification (6) comprises at least one steganographic feature (4) having a length greater than 0.01 mm. The training dataset (7) further comprises an associated class definition based on the steganographic feature of the authentic product specification of the authentic product (not shown). The training dataset (7) further comprises an associated class definition based on the camera type of the digital image obtaining camera device (13) (such as a computing device, e.g., mobile phone) which was used to obtain images of the authentic product (8) (having an authentic product specification (6)). The term “camera type” means an attribute of a camera that can distinguish it from another camera, such as but not including make and model of the camera. Without wishing to be bound by theory, the electronics or software (specific to the make or model of the camera) may influence the extracted image. The type of optics used by the camera is another way of defining the camera type. Non-limiting examples of manufacturers of lens include Leica, Carl Zeiss, and Schneider-Kreuznach. Without wishing to be bound by theory, the optics of the lens may influence the extracted image. The training dataset may comprise extracted images of an authentic product specification, wherein the authentic product specification comprises a Manufacturing Line Variable Printing Code (10) (defined below). In this example, the training dataset further comprises an associated class definition based on the Manufacturing Line Variable Printing Code (not shown).

“Steganographic feature” means an alphanumerical, graphical, structural feature, or the like, that is that is deliberately added to the physical consumer good as to be plainly visible detectable on the consumer good but preferably does not attract attention. Preferably the steganographic feature is large enough as to not require microscopy to be visible. An advantage of features that are larger than a microscopic level is that ability to detect them by a typical smart phone or other standard device, or computing device, such as mobile phone, that many consumers routinely carry with them. More preferably the steganographic feature has a length (i.e., longest dimension) from 0.02 mm to 20 mm, more preferably from 0.03 mm to 5 mm, yet more preferably from 0.04 mm to 1 mm Non-limiting examples of this length include 0.03 mm, 0.05 mm, 0.07 mm, 0.09 mm, 0.1 mm, 0.2 mm, 0.3 mm, 0.4 mm, 0.5 mm, and 0.6 mm.

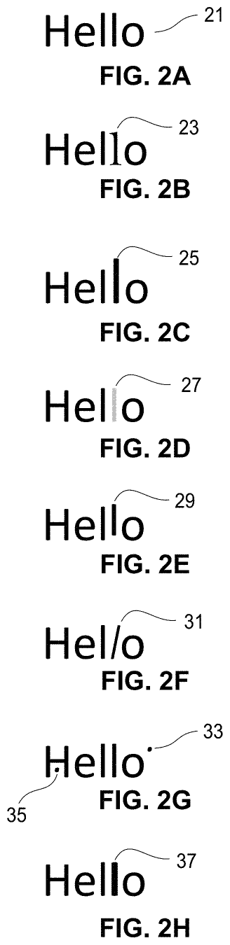

“Alphanumerical steganographic feature” is a feature associated with letters, numbers, punctuation, characters, and the like. FIG. 2A-2H are non-limiting examples directed to the word “Hello.” FIG. 2A is a control example where the word “Hello” (21) is typed in standard font and font size. FIG. 2B is an example where the second “1” (23) is in a different style as compared to the other letters of the word. FIG. 2C has the second “1” (25) is a larger font size. This “1” can be bolder or alternatively even a smaller size as compared to the other letters of the word. FIG. 2D is an example where the second “1” (27) is a color or shading or grayscale intensity that is different as compared to the other letters of the word. In FIG. 2E the second “1” (29) is shifted slightly upwards as compared to the other letters of the word. Alternatively, this shifting can be down, left, right, or combinations thereof. In FIG. 2F, the second “1” (31) is italicized. In FIG. 2G, there is are marks (33, 35) (alternatively a character or punctuation) that are randomly placed next to the letter “H” (35) and next to the letter “o” (33). In another example, not shown, a period that is placed in a slightly elevated position as compared to a customary placement. In FIG. 2H, the second letter “1” (37) is bolded. Alternatively, the letter can be un-bolded (relatively to the other letters of the word). Other examples may include “cutting” a small section of a logo.

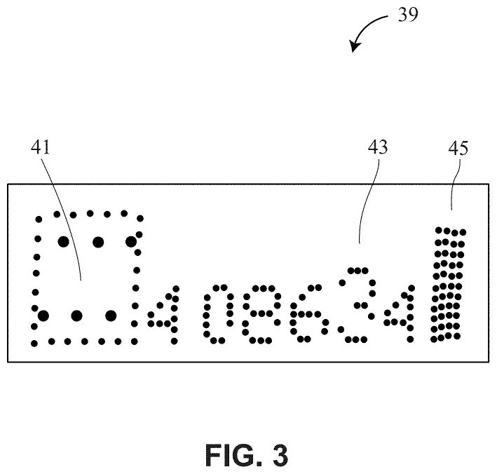

FIG. 3 is an example of Manufacturing Line Variable Printing Code (“Code”) (39). This Code (39) may have alphanumeric characters or non-alphanumeric characters or combinations thereof. In FIG. 3, the alphanumeric characters are specifically “408634.” This Code is printed while the consumer product is being manufactured, preferably as one of the last steps before being packed for shipping. The Manufacturing Line Variable Printing Code is printed by a printing method selected from: continuous ink-jet; embossing, laser etching, thermal transferring, hot waxing, and combinations thereof; preferably continuous ink-jet. Continuous ink-jet is typically black ink, where characters are made up of small drops or dots. Embossing is typically seen in bags or carton packaging. Laster etching is typically used on plastic, metal, or cardboard. Thermal transferring is typically seen in label or flexible packaging. Hot waxing is seen, for example, in some diaper products. The Code is variable because the exact character(s) may change from time to time to address variables such as expiration date of the product, production date of the product, lot numbers, etc. The Code can serve other functions such as identify the manufacturing plant, or a unique product identifier. The Code may or may not contain a steganographic feature. For example, the number “3” (43) is slightly larger than the other numbers. It is surprisingly observed that given the conditions of the manufacturing line (e.g., high speed), the variability between printers and substrates, the characteristics of the ink itself that the Codes often great unique “fingerprints” with features, of example, of magnitudes of 0.1-0.5 mm in length (i.e., long dimensions) and can be form valuable part of the training dataset (alternatively, or in addition, the validating or testing dataset(s)). Preferably each character has a length (i.e., longest dimension) from 2 mm to 50 mm, alternatively from 10-30 mm, or from 5-15 mm, or from 20-50 mm.

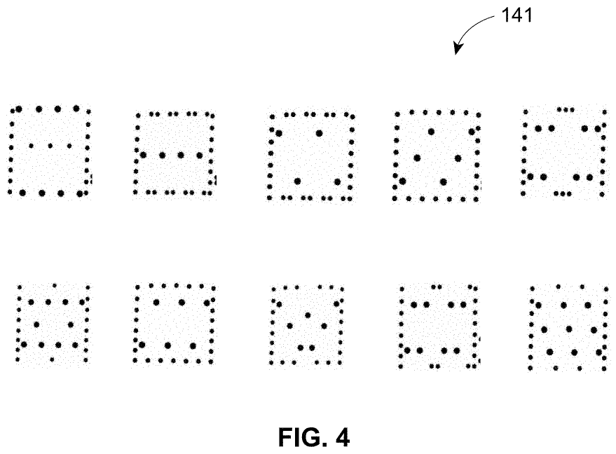

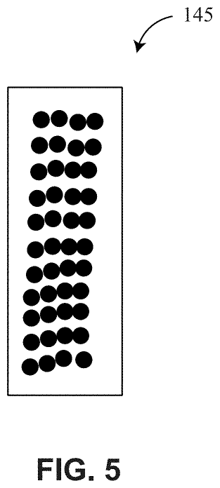

“Graphical steganographic feature” is a feature that is typically associated with artwork, graphics, or even nonsensical patterns or markings. In one example, a small portion of a graphic is “cut”. In another example, turning to back to FIG. 3, the Manufacturing Line Variable Printing Code comprises a non-alphanumeric character, such as a patterned box made from dots (41) and a dotted column (45) are provided as part of a manufacturing (batch) code. FIG. 4 are different examples of the pattern box (141) that may be used. FIG. 5 is an example of a dotted column (145). The numbers can be printed from different fonts or font styles. The numbers can be stretched or shrunk and the dots or lines that comprise the number or letter can be arranged in a manner that is not evenly spaced. This includes overlapping dots/lines or even “missing” dots or discontinuous lines. Generally, given the degree and amount of “errors” in the Code (whether these errors are deliberating made or inherently by the printing process), regardless provides a unique “fingerprint” for authentic products so that the methods and systems herein described can determine non-authentic products with a high speed and/or accuracy.

Many of these steganographic features can be automatically deliberately generated by software, such as bespoke plug-ins for Adobe Illustrator in the case of steganographic features in artworks, or modification to software controlling the online printers or the online printing software itself for steganographic features in the manufacturing line variable printed code. In one example, as illustrated in FIG. 1A, a validating dataset (5), training dataset (7), testing dataset (not shown), or combination thereof, preferably only the validating dataset (5), comprises a key from the automated steganographic feature generating software (3) identifying the features. In another example, a validating dataset, training dataset, or combination thereof, preferably only the validating dataset, comprises using information about the characteristic of the Manufacturing Line Variable Printing Code. This way the model knows what these steganographic features are and where these steganographic features are located (and can weigh them in the model as appropriate). In other words, the training dataset further comprises identification of the steganographic feature(s) of the product specification (of the authentic consumer good) generated by steganographic feature generating software.

“Structural feature” is one where the feature is part of the packaging itself (vs. printed). This may include a feature that is part of the bottle, i.e., designed as part of the bottle mold. The feature can be a deliberated placed small protrusion or recession or combination thereof (e.g., pattern or texture). In another example, the structural feature is a unique portion of a seal of a bag (e.g., a small section of a unique pattern in the context of an otherwise much larger standard pattern). In yet another example, the feature is a small cut-out made into the edge of the bag (e.g., in the seal portion). In yet another example, the cardboard packaging of a product is embossed (e.g., with a pattern or texture).

Preferably the one or more product specifications comprise a plurality of steganographic features, preferably greater than 10, 15, 20, 25, 30 or more such features are used in the product description, alternatively from 5 to 100, or from 10 to 90, or from 20 to 70. Preferably at least two of the following steganographic feature types are used: textual steganographic feature; graphical steganographic feature; and structural feature. Alternatively, all three of such types are used.

An advantage of having a plurality of steganographic features and feature types is the ability to detect counterfeits with better accuracy given that more “fingerprints” are available for detection by the model and/or given flexibility that the image obtained need not be from a single rigid vantage point. In other words, accuracy is relatively high regardless of what perspective the image is taken of the product.

Preferably the training dataset comprises an annotation annotating the steganographic feature or Manufacturing Line Variable Printing Code. The annotations, to the images forming a part of the training dataset, provides details or characteristics of said features or Codes. This may help the model learn. The annotation may be individually sourced, or crowd sourced. For example, when crowd sourced, if three more contributors independently annotate the same image, and standard deviation is reasonably low, the annotation is accepted into the model. The approach can also be used as part of a validation step. Alternatively, the training set is augmented to emphasize said feature or Code.

### Camera Type

Camera bias can have a large effect on modeling training. The present invention is directed, at least in part, to address this bias to improve the predictive accuracy of the model. The methods herein comprise the use of a training dataset which includes at least one, preferably a plurality of images (hundreds, thousands, or even tens of thousands of images) that are extracted from a plurality of different camera types.

Preferably the method comprises a training dataset which further comprises a plurality of extracted images, from a plurality of different camera types, of an authentic product comprising an authentic product specification, and wherein the plurality of different camera types is from at least 3 different camera types, preferably 4, 5, 6, or more camera types. More preferably, the method further comprises the training dataset further comprises extracted images, from the aforementioned plurality of different camera types, of non-authentic product comprising a non-authentic product specification, wherein the non-authentic product specification is different from (e.g., devoid of or differently configured from) said at least one steganographic feature. Even more preferably the training set has a balance set of extracted images from both authentic and non-authentic corresponding consumer goods. The balance is about 50/50 of authentic and non-authentic of the extracted images of said plurality of different camera types, respectively. Additionally, or alternatively, balance of a training set may comprise balancing a number of training samples, from each of the plurality of different camera types, used to train a model. In such embodiments, balance may refer to an equal number, or approximately equal number of, training samples, from each of the plurality of different camera types. In embodiments comprising an approximately equal number, such training samples, amounts may differ, across a given training set, at values of less than 5%, less than 3%, less than 1%, or less than 0.1% compared with sample counts as provided from each of the remaining camera types. Such percentages may also be applied on an authentic and non-authentic basis, where each training set for authentic and non-authentic may differ, across a given training set, at values of less than 5%, less than 3%, less than 1%, or less than 0.1% compared with sample counts as provided from each of the plurality of camera types. Without wishing to be bound by theory, having using the same camera types and an equal number extract images of the authentic and non-authentic images helps to build a balanced model that reduces bias that may otherwise reduce the predicative accuracy of the model. Preferably the plurality of different camera types is at least 3, preferably at least 4, more preferably at least 5, camera types. The advantage is the model is built to accommodate different cameras that be used by users and help mitigate camera bias that may otherwise affect the model. Examples below demonstrates a reduction to camera bias in model training Preferably the images are taken from a smart phone, i.e., camera phone.

Preferably the method comprises a training dataset, which further comprises an augmented extracted images of an authentic product having an authentic product specification with either a geometric distortion or a color distortion, preferably both geometric and color distortions. A geometric distortion means changing the shape of the original extract image, for example of square or rectangle, to a polygon, a regular polygon or an irregular polygon. A color distortion means changing the color of the original extracted image (e.g., text or background or both). Without wishing to be bound by theory, such geometric and color distortions help generalization to the test set but also removes any correlations that may exist between class label and white balance, saturation, hue, and container (e.g., bottle) orientation. This may narrow down the list of cues the model may be exploiting to recognize cameras.

The consumer good, to which authenticity is determined, can be essentially any consumer good that is sold in commerce. Non-limiting examples of consumer goods include medicine, prescription drugs, airplane parts, food, beverages, automobile parts, and the like. Preferably the consumer good a fast-moving consumer good. Non-limiting examples include fabric care products (e.g., laundry detergent, fabric softener), home care product (e.g., dishwashing detergent, disposable duster), baby care products (e.g., diaper), beauty care products (e.g., shampoo, skin cream, antiperspirant), family care products (e.g., facial tissue, disposable towel), feminine care products (e.g., tampon, sanitary napkin), heath care products (e.g., toothpaste, toothbrush, over-the-counter cough and cold medicine, vitamin, gastrointestinal remedy).

The training dataset preferably also comprises at least one image extracted from at least a non-authentic consumer good and its product specification, and an associated class definition based on the absence of the least one steganographic feature in the product specification of the non-authentic consumer good. The optional validation dataset may also contain images extracted from a non-authentic physical consumer good and its product specification, and an associated class definition based on the absence of the least one steganographic feature in the product specification of the non-authentic physical consumer good.

Preferably the dataset (i.e., training and/or validation datasets) is spatially manipulated before the machine learning classifier is trained. More preferably the data set is spatially manipulated by a Spatial Transformer Network (“STM”). STM is a learnable module that learns to select the correct region of the input image data, rotate that portion of the image to normalize the pose, and scale the cropped region before inputting into the machine learning classifier. For example, interfering features of the background of the input image data are removed. The geometric invariance to the CNN is improved. A STM typically as three main components. A localization network learns automatically the spatial transformation that enhances accuracy (i.e., reinforcement learning). A grid generator generates a grid of coordinates in the input image data corresponding to each pixel from the output image. And a sampler uses the parameters from the transformation and applies to the input image data to provide the spatially transformed image data. See e.g., Jaderberg, M., Simonyan, K., & Zisserman, A. (2015), “Spatial transformer networks,” In Advances in Neural Information Processing Systems (pp. 2017-2025). This reference is incorporated by reference herein. The input image data (of the dataset) is spatially transformed, preferably by way of a STN, to a spatially transferred image data. In turn, it is this spatially transformed dataset that is used to train the machine learning classifier. Of course, the STM can be applied to the optional validation datasets.

The machine learner classifier is optimized. Preferably the CNN is optimized by stochastic optimization techniques. This may include Adadelta, Adagrad, Adam, Adamax, ASGD, L-BFGS and SGD. Adam is a preferred method for stochastic optimization herein. Briefly, Adam is an optimization algorithm that can be used to update network weights iteratively based on training data.

In one example, the classification architecture requires a small amount of data and operates on relatively high-resolution images. It can be a residual network pre-trained on ImageNet, but with higher resolution (1024\hat{ }2) images than typical architectures. Such an approach helps find subtleties characteristic of steganographic features or MVLP Codes. As such, the batch size may be decreased in size and decrease the learning rate of the stochastic gradient descent optimizer.

The method comprises a step of obtaining a digital image of the subject consumer good having a subject product specification. One or more digital images is obtained by a digital image obtaining device or other computing device such as a smart phone (e.g., iPhone), tablet (iPad), personal computer, or similar device that is preferably capable of capturing digital pictures and is directly or indirectly capable of electrically sending the image to the model. In another example, the digital image is obtained from a website (as to determine whether a counterfeiter is offering a non-authentic product at e-retailer website). Preferably the digital image can capture images such that the steganographic features are shown. The “product specification” includes the production code, batch code, brand name, product line, label, artwork, ingredient list, usage instructions, and combinations thereof. Preferably the product specification is selected from production code, batch code, and combination thereof. If the subject product is authentic, the product specification(s) will have one or more steganographic features that are captured in the digital image. Preferably the digital image data of the subject consumer good is spatially manipulated, preferably by STM, before being inputted into the model.

The method comprises a step of inputting the obtained image into a model, wherein the model is configured to classify the obtained image as authentic or non-authentic. The method of inputting depends in where the model resides. For example, the trained model may reside on the digital imaging obtaining device, e.g., computing device or mobile device, itself, or more preferably, in a remote location such as a server (e.g., cloud-based server). If the model is remote, inputting can be via a network (e.g., internet or cellular network or the like).

For example, FIG. 1D illustrates an example machine learning based imaging system (200) configured to image and classify whether one or more physical and subject consumer goods are authentic or non-authentic, in accordance with various embodiments disclosed herein. In the example embodiment of FIG. 1D, digital imaging system (200) includes server(s) (202), which may comprise one or more computer servers. In various embodiments server(s) (202) comprise multiple servers, which may comprise a multiple, redundant, or replicated servers as part of a server farm. In still further embodiments, server(s) (202) may be implemented as cloud-based servers, such as a cloud-based computing platform. For example, imaging server(s) (202) may be any one or more cloud-based platform(s) such as MICROSOFT AZURE, AMAZON AWS, or the like. Server(s) (202) may include one or more processor(s) (204) as well as one or more computer memories (206). Server(s) (202) may be referred to herein as “imaging server(s).”

The memories (206) may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memorie(s) (206) may store an operating system (OS) (e.g., Microsoft Windows, Linux, UNIX, etc.) capable of facilitating the functionalities, apps, methods, or other software as discussed herein. The memorie(s) (206) may also store model 11, which, as described herein, may be an artificial intelligence based model, such as a machine learning model, trained on various images (e.g., images (222a), (222b), and/or (222c)), as described herein. For example, each of images (222a), (222b), and/or (222c) may be images depicting a consumer good (70) (e.g., a bottle-based product, e.g., a shampoo bottle) having a subject product specification, e.g., a Manufacturing Line Variable Printing Code (39), as printed or otherwise affixed on a consumer good (70), for example, as described for FIG. 1C herein.

Additionally, or alternatively, the model (11) may also be stored in database (205), which is accessible or otherwise communicatively coupled to imaging server(s) (202). The memories (206) may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, an imaging based machine learning model or component, such as the model (11), where each may be configured to facilitate their various functionalities discussed herein. It should be appreciated that one or more other applications may be envisioned and that are executed by the processor(s) (204).

The processor(s) (204) may be connected to the memories (206) via a computer bus responsible for transmitting electronic data, data packets, or otherwise electronic signals to and from the processor(s) (204) and memories (206) in order to implement or perform the machine readable instructions, methods, processes, elements or limitations, as illustrated, depicted, or described for the various flowcharts, illustrations, diagrams, figures, and/or other disclosures herein.

The processor(s) (204) may interface with the memory (206) via the computer bus to execute the operating system (OS). The processor(s) (204) may also interface with the memory (206) via the computer bus to create, read, update, delete, or otherwise access or interact with the data stored in the memories (206) and/or the database (204) (e.g., a relational database, such as Oracle, DB2, MySQL, or a NoSQL based database, such as MongoDB). The data stored in the memories (206) and/or the database (205) may include all or part of any of the data or information described herein, including, for example, training images and/or images (e.g., either of which including any one or more of images (222a), (222b), and/or (222c)) or other information as described herein.

The imaging server(s) (202) may further include a communication component configured to communicate (e.g., send and receive) data via one or more external/network port(s) to one or more networks or local terminals, such as computer network 120 and/or terminal (209) (for rendering or displaying) described herein. In some embodiments, imaging server(s) (202) may include a client-server platform technology such as ASP.NET, Java J2EE, Ruby on Rails, Node.js, a web service or online API, responsive for receiving and responding to electronic requests. The imaging server(s) (202) may implement the client-server platform technology that may interact, via the computer bus, with the memories(s) (206) (including the applications(s), component(s), API(s), data, etc. stored therein) and/or database (205) to implement or perform the machine readable instructions, methods, processes, elements or limitations, as illustrated, depicted, or described for the various flowcharts, illustrations, diagrams, figures, and/or other disclosure herein. According to some embodiments, the imaging server(s) (202) may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to computer network 120. In some embodiments, computer network 120 may comprise a private network or local area network (LAN). Additionally, or alternatively, computer network 120 may comprise a public network such as the Internet.

Imaging server(s) (202) may further include or implement an operator interface configured to present information to an administrator or operator and/or receive inputs from the administrator or operator. As shown in FIG. 1D, an operator interface may provide a display screen (e.g., via terminal (209)). Imaging server(s) (202) may also provide I/O components (e.g., ports, capacitive or resistive touch sensitive input panels, keys, buttons, lights, LEDs), which may be directly accessible via or attached to imaging server(s) (202) or may be indirectly accessible via or attached to terminal (209). According to some embodiments, an administrator or operator may access the server (202) via terminal (209) to review information, make changes, input training data or images, and/or perform other functions.

As described above herein, in some embodiments, imaging server(s) (202) may perform the functionalities as discussed herein as part of a “cloud” network or may otherwise communicate with other hardware or software components within the cloud to send, retrieve, or otherwise analyze data or information described herein.

In general, a computer program or computer based product, application, or code (e.g., the model(s), such as AI models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) (204) (e.g., working in connection with the respective operating system in memories (206)) to facilitate, implement, or perform the machine readable instructions, methods, processes, elements or limitations, as illustrated, depicted, or described for the various flowcharts, illustrations, diagrams, figures, and/or other disclosures herein. In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.).

As shown in FIG. 1D, imaging server(s) (202) are communicatively connected, via computer network 120 to the one or more mobile devices 211c1-211c3 and/or 212c1-212c3 via base stations 211b and 212b. Each of the one or more mobile devices 211c1-211c3 and/or 212c1-212c3 may be a digital image obtaining camera device (13), e.g., a computing device, such as a mobile device or mobile phone, as described herein. In some embodiments, base stations 211b and 212b may comprise cellular base stations, such as cell towers, communicating to the one or more mobile devices 211c1-211c3 and 212c1-212c3 via wireless communications 221 based on any one or more of various mobile phone standards, including NMT, GSM, CDMA, UMMTS, LTE, 5G, or the like. Additionally or alternatively, base stations 211b and 212b may comprise routers, wireless switches, or other such wireless connection points communicating to the one or more mobile devices 211c1-211c3 and 212c1-212c3 via wireless communications 223 based on any one or more of various wireless standards, including by non-limiting example, IEEE 802.11a/b/c/g (WIFI), the BLUETOOTH standard, or the like.

Any of the one or more mobile devices 211c1-211c3 and/or 212c1-212c3 may comprise mobile devices and/or client devices for accessing and/or communications with imaging server(s) (202). In various embodiments, mobile devices 211c1-211c3 and/or 212c1-212c3 may comprise a cellular phone, a mobile phone, a tablet device, a personal data assistance (PDA), or the like, including, by non-limiting example, an APPLE iPhone or iPad device or a GOOGLE ANDROID based mobile phone or table. Any of the one or more mobile devices 211c1-211c3 and/or 212c1-212c3 may comprise one or more processors and/or one or more memories for storing, implementing, or executing computing instructions or code, e.g., a mobile app. As shown in FIG. 1D, model 11 may also be stored locally on a memory of a mobile device (e.g., mobile device 211c1).

Mobile devices 211c1-211c3 and/or 212c1-212c3 may comprise a wireless transceiver to receive and transmit wireless communications 221 and/or 223 to and from base stations 211b and/or 212b. Pixel based images (222a), (222b), and/or (222c) may be transmitted via computer network 120 to imaging server(s) (202) for training of model(s) (e.g., model 11) and/or performing imaging analysis as describe herein.

In addition, the one or more mobile devices 211c1-211c3 and/or 212c1-212c3 may include a digital camera and/or digital video camera for capturing or taking digital images and/or frames (e.g., which can be any one or more of images (222a), (222b), and/or (222c)). Each digital image may comprise pixel data for training or implementing model(s), such as AI or machine learning models, as described herein. For example, a digital camera and/or digital video camera of, e.g., any of mobile devices 211c1-211c3 and/or 212c1-212c3, may be configured to take, capture, or otherwise generate digital images (e.g., pixel based images (222a), (222b), and/or (222c)) and, at least in some embodiments, may store such images in a memory of a respective mobile devices. For example, each of images (222a), (222b), and/or (222c) may be images depicting a consumer good (70) (e.g., a bottle-based product, e.g., a shampoo bottle) having a subject product specification, e.g., a Manufacturing Line Variable Printing Code (39), as printed or otherwise affixed on a consumer good (70), for example, as described for FIG. 1C herein.

Still further, each of the one or more mobile devices 211c1-211c3 and/or 212c1-212c3 may include a display screen for displaying graphics, images, text, product recommendations, data, pixels, features, and/or other such visualizations or information as described herein. In various embodiments, graphics, images, text, data, pixels, features, and/or other such visualizations or information may be received by imaging server(s) (202) for display on the display screen of any one or more of mobile devices 211c1-211c3 and/or 212c1-212c3. Additionally, or alternatively, a mobile device may comprise, implement, have access to, render, or otherwise expose, at least in part, an interface or a guided user interface (GUI) for displaying text and/or images on its display screen, e.g., as described for FIG. 1C herein.

The systems and methods herein comprise the step of outputting output from the model classifying the image of the subject good as authentic or non-authentic. The output is preferably received on the same device that captured the image of the subject consumer good. Additional output may include providing instructions to the user how to report the non-authentic consumer good or where an authentic consumer good can be purchased, e.g., on-line or nearest off-line store. Preferably the method is accomplished within 5 seconds, preferably within 3 seconds, more preferably within 1 seconds; alternatively, from 1 to 5 seconds. In one aspect, of the invention, the data is only collected from a mobile device, e.g., a mobile phone, e.g. in a crowdsourcing activity and then processed internally to generate a real-time geo-located picture of counterfeits in the market with or without reporting the conclusion back to the user. In one example, the output indicates that the initial obtained image (that was inputted in the model) was inclusive and the user should obtain (and input) another image of the subject consumer product given that the analysis is inconclusive. And a better quality image, or an image from another perspective etc., is needed for a before a final or more definitive classification of authenticity can be provided.

### Example

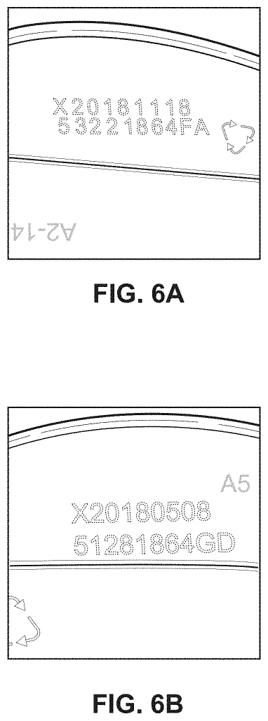

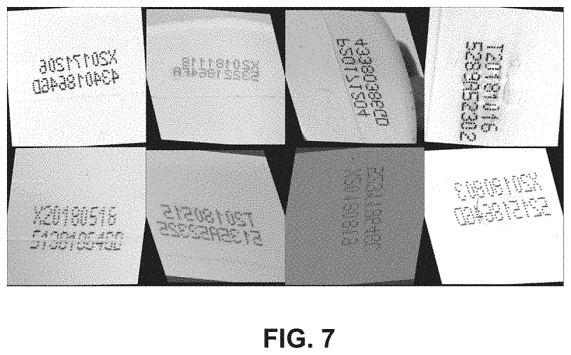

Camera bias to the model is mitigated as demonstrated herein. Our training set consists of 2331 red-green-blue (RGB) based images of the undersides of shampoo bottles. RGB is a file extension for an image file created on a Silicon Graphics workstation. RGB files can contain Run Length encoding (RLE) compressed or uncompressed images in grayscale or color and supports optional transparency. RGB files can be opened and edited by most image editors. These images are of size 1024×1024 and are cropped tightly around the bottle's batch code, which is a two-line alphanumeric serial number printed by a dot matrix printer (see FIG. 6). FIGS. 6A and 6B are a pair of images from the training set. FIG. 6A is taken with an APPLE iPhone camera, while FIG. 6B is taken with a SAMSUNG mobile device camera. The batch codes of counterfeit products are expected to differ from those of genuine articles in some potentially very subtle ways, hence the relatively high resolution of our images.

Our images are captured with four different cameras: iPhone, Huawei, Samsung, and Redmi. In the base dataset these cameras occur at equal frequencies among the authentic and non-authentic classes, but by excluding certain combinations of camera and label from the dataset, we can introduce correlations between camera type and class label. The images are acquired by four people who each photographed an equal number of images from each class and with each camera, all in the same room, under controlled lighting conditions. By standardizing environmental conditions like so, we can be surer that it is the correlation between camera type and label that the model exploits, and not some other source of domain bias. The validation set is a hold-out set comprising a random 10% of the training samples, on which the model is never trained. The test set contains 1046 images, acquired a year later than the train set with the same cameras, again distributed equally across both classes.

We run a series of classification experiments on variations of our dataset with camera/label correlation artificially introduced. All experiments are trained to 10,000 iterations (47 epochs in our dataset with a batch size of 8), with a learning rate of 10⁻⁴. To prevent finite sample overfitting on our small dataset, we employ some standard data augmentations: horizontal flipping, random rotation, color jitter, and shear (see FIG. 7). FIG. 7 shows examples of augmenting training images with basic geometric and color distortions. All accuracy numbers we report are averaged over four runs with different random number generator seeds.

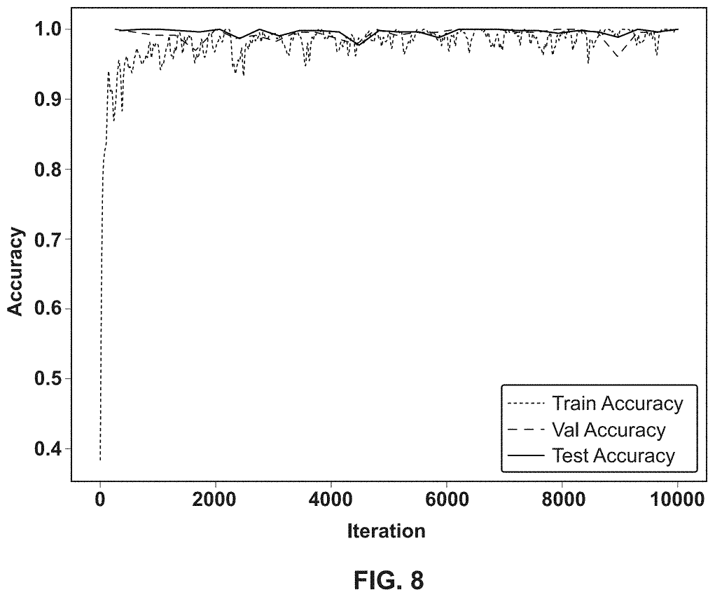

We verify here that state of the art vision models can very easily classify which camera took the image in this dataset. Table 1 shows that very high test accuracies can be achieved on this task across a range of architectures. As FIG. 8 shows, a pretrained ResNet34 model not only achieves high accuracy at camera classification but does so very quickly. In this run, a pretrained model ResNet34 achieves close to perfect test accuracy within a single training epoch (comprising 2331 camera labelled images). The ease with which models can identify cameras suggests that when the distinction between classes is very small, as is often the case with fine grained classification, CNNs will cheat by using camera to identify the class.

TABLE 1
Accuracy (%) on the test set when classifying
which camera took an image.

| Model | Test Accuracy |
|---|---|
| ResNet34 | 1.000 |
| ResNet101 | 0.935 |
| Inception V3 | 0.999 |
| AlexNet | 0.931 |
| VGG16 | 0.923 |

We investigate our primary task, counterfeit detection, under three settings, which we refer to as Balanced, Partial, and Disjoint. In the Balanced setting, we use the full training set and there are no correlations between camera type and class label. In Partial, we use the same training set but with only iPhone and Samsung cameras included. In Disjoint, we introduce correlations between camera and class label by including only authentic labelled images taken with iPhone or Samsung cameras, and non-authentic labelled images taken with Huawei or Redmi cameras. Our test set is the same in all cases, balanced across camera types with no camera/label correlations.

TABLE 2
Counterfeit detection test set accuracy of
five models with different training setups.

| Model | Balanced | Partial | Disjoint |
|---|---|---|---|
| ResNet34 | 0.820 | 0.859 | 0.546 |
| ResNet101 | 0.786 | 0.721 | 0.533 |
| InceptionV3 | 0.830 | 0.846 | 0.534 |
| AlexNet | 0.709 | 0.745 | 0.656 |
| VGG16 | 0.821 | 0.809 | 0.768 |

Table 2 shows the results of counterfeit classification experiments on these three datasets. It is immediately apparent that while respectable accuracy is achieved when training on the Balanced dataset (and the Partial dataset), an accuracy drop of around 30% occurs when training on Disjoint (e.g., compared with each of the Balanced and/or Partial dataset with respect to various models). In fact, Disjoint accuracy is close to 50%, hardly better than random guessing, which is entirely expected if the model were basing its classifications on camera types, each of which has an equal number of authentic and non-authentic images in the test set.

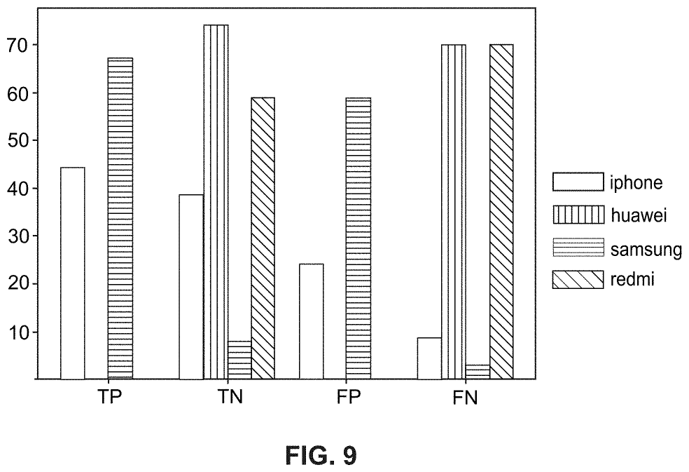

We can confirm that this drop-in accuracy is due to camera bias by observing the model's behavior across camera types in the test set. As FIG. 9 shows, a ResNet34 trained on the Disjoint dataset scores true positives and false positives exclusively on test images acquired by iPhone or Samsung cameras, while negative responses occur overwhelmingly on Huawei and Redmi images. Similar behavior is observed in the other models, to varying extents. FIG. 9 is a bar graph showing distribution of True Positive (TP), True Negative (TN), False Positive (FP), and False Negative (FN) responses on our test set, for a ResNet34 model trained on the Disjoint training set, in which all authentic (positive) images are iPhone or Samsung, and all non-authentic (negatives) are Huawei or Redmi. Positive responses occur exclusively for iPhone and Samsung samples, while negative responses occur overwhelmingly on Huawei and Redmi samples, thereby proving the model has exploited the camera/label correlation in the training set.

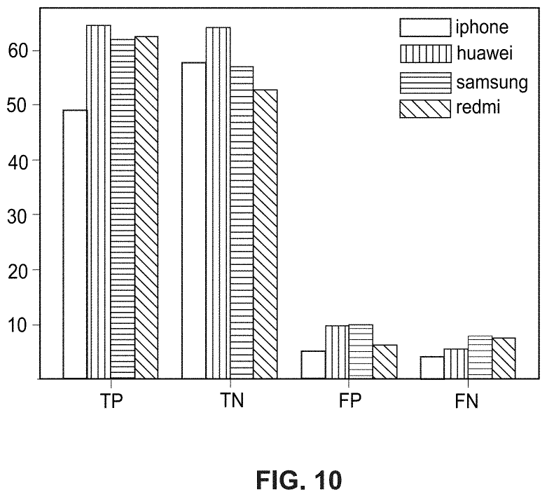

When training on the Partial dataset, where only iPhone and Samsung images are present, but no camera/label correlation exists, test accuracy is broadly similar to training on the full (Balanced) dataset. Not only is accuracy high, but as FIG. 10 shows, the model performs well on the unseen (or unknown at the time) cameras. This implies that in the absence of camera/label correlation, the model learns a robust classification rule that is unaffected by camera type. FIG. 10 is a bar graph showing distribution of True Positive (TP), True Negative (TN), False Positive (FP), and False Negative (FN) responses on our test set, for a ResNet34 model trained on the Partial training set, in which only iPhone or Samsung images are present, but with no camera/label correlation. Accuracy is high even on the unseen Huawei and Redmi camera, implying that the model has learned robust classification rule that generalizes across cameras.

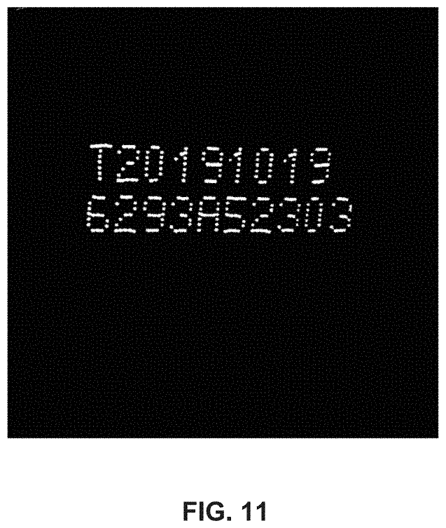

There is a finite set of image features that may be used to infer the camera type from which an image originates. Since most of these features relate to color distribution or high frequency detail (i.e. texture), it seems likely that removal of these features would render camera type identification impossible, and hence resolve the domain bias issues. To do this while preserving features that are likely relevant for robust counterfeit detection, we apply local mean thresholding to the images. This yields a binary image that effectively segments the dots of the batch codes while removing all elements of color and texture (see FIG. 11). FIG. 11 is an image of a batchcode from a bottle, with local mean thresholding applied segmenting the batchcode dots. Origin camera classification does not work on such images, indicating that models use something other than the shape and position of the dots to classify camera types.

As Table 3 shows, training on binary segmented images does not yield usable results on the counterfeit detection or camera classification tasks—in both cases, the test accuracy is close to the level expected of random guessing. As expected, we also observed no significant correlation between non-authentic classification test accuracy and camera type when training on the Disjoint dataset with binary thresholding. This largely rules out lens distortion or other large scale geometric artifacts as the source of camera bias, since these distortions would cause the dots to move and thus be visible in the binary thresholded images.

TABLE 3
provides non-authentic and camera type accuracy (%)
on the test set when trained (and tested) on
binary segemented images such as FIG. 11.

| | Test Accuracy (%) | |
|---|---|---|
| Model | Non-authentic | Camera Type |
| ResNet34 | 0.515 | 0.268 |
| ResNet101 | 0.483 | 0.255 |
| InceptionV3 | 0.554 | 0.247 |
| Alexnet | 0.516 | 0.255 |
| VGG16 | 0.610 | 0.279 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

### ASPECTS OF THE PRESENT DISCLOSURE

The following aspects of the disclosure are exemplary only and not intended to limit the scope of the disclosure.

1. A method for classifying whether a subject consumer good is authentic or non-authentic comprising the steps: a) obtaining an image of the subject consumer good comprising a subject product specification; b) inputting the obtained image into a model, wherein the model is configured to classify the obtained image as authentic or non-authentic, wherein the model is constructed by a machine learning classifier, wherein the machine learning classifier is trained by a training dataset, wherein the training dataset comprises: (i) extracted images, from a plurality of different camera types, of an authentic product comprising an authentic product specification, wherein said authentic product specification comprises at least one steganographic feature having a length greater than 0.01 mm; and (ii) an associated class definition based on said steganographic feature (of said authentic product specification of said authentic product); and c) outputting output from the model classifying the inputted image of the subject consumer good as authentic or non-authentic.

2. The method of aspect 1, wherein said plurality of different camera types is at least 3, preferably at least 4, more preferably at least 5, camera types.

3. The method of aspect 1 or 2, further comprising the step of augmenting said extracted images of the authentic product with geometric distortion or color distortion, preferably with both geometric and color distortions.

4. The method of any one of the preceding aspects, wherein the steganographic features has a length from 0.02 mm to 20 mm, more preferably from 0.03 mm to 5 mm, yet more preferably from 0.04 mm to 1 mm.

5. The method of any one of the preceding aspects, wherein the machine learning classifier is validated by a validating dataset, wherein the validating dataset comprises identification of the steganographic feature(s) of the product specification (of the authentic consumer good) generated by steganographic feature generating software; preferably training dataset comprises annotations annotating the steganographic feature(s).

6. The method of any one of the preceding aspects, wherein the steganographic features is selected from: isolated font style for a letter or number or combination thereof; isolated location change of location of text, letter, punctuation, or combination thereof; and combinations thereof;

preferably the steganographic features is automatically generated by way of software.

7. The method of any one of the preceding aspects, wherein the product specification is selected from the group consisting of production code, batch code, brand name, product line, label, artwork, ingredient list, usage instructions, and combinations thereof, preferably the product specification is selected from production code, batch code, and combination thereof.

8. The method of any one of the preceding aspects, wherein the machine learning classifier is a convolutional neural network (“CNN”).

9. The method of any one of the preceding aspects, wherein the training dataset is spatially manipulated before training the machine learning classifier; preferably the training dataset is spatially manipulated by way of a spatial transformer network; more preferably the training dataset emphasizes high frequencies features.

10. The method of any one of the preceding aspects, wherein the obtained image of the subject consumer good is spatially manipulated before being inputted into the model, preferably wherein the obtained image is spatially manipulated by way of a spatial transformer network.

11. The method of any one of the preceding aspects, wherein the training dataset further comprises extracted images, from said plurality of different camera types, of non-authentic product comprising a non-authentic product specification, wherein the non-authentic product specification is different from said at least one steganographic feature;

wherein said plurality of different camera types is at least 3, preferably at least 4, more preferably at least 5, camera types.

12. A method for classifying whether a subject consumer good is authentic or non-authentic comprising the steps: a) obtaining an image of the subject consumer good comprising a subject product specification; b) inputting the obtained image into a model, wherein the model is configured to classify the obtained image as authentic or non-authentic, wherein the model is constructed by a machine learning classifier, wherein the machine learning classifier is trained by a training dataset, wherein the training dataset comprises: (i) extracted images, from a plurality of different camera types, of an authentic product comprising an authentic product specification, wherein said authentic product specification comprises Manufacturing Line Variable Printing Code; (ii) extracted images, from said plurality of different camera types, of non-authentic product comprising a non-authentic product specification, wherein the non-authentic product specification is different from said at least one steganographic feature; and (iii) an associated class definition based on said Manufacturing Line Variable Printing Code (of said authentic product specification of said authentic product); and c) outputting output from the model classifying the inputted image of the subject consumer good as authentic or non-authentic.

13. The method of aspect 12, wherein said plurality of different camera types is at least 3, preferably at least 4, more preferably at least 5, camera types.

14. The method of aspect 12 or 13, further comprising the step of augmenting said extracted images of the authentic product with geometric distortion or color distortion, preferably with both geometric and color distortions.

15. The method of aspect 12, 13, or 14 wherein Manufacturing Line Variable Printing Code comprises alphanumeric character, non-alphanumeric character, or combinations thereof; preferably training dataset comprises annotations annotating the Manufacturing Line Variable Printing Code, preferably wherein Manufacturing Line Variable Printing Code is printed by a printing method selected from: continuous ink-jet; embossing, laser etching, thermal transferring, hot waxing, and combinations thereof; preferably continuous ink-jet, and more preferably the Manufacturing Line Variable Printing Code comprises a non-alphanumeric character, where the non-alphanumeric character comprises a pattern box, a dotted column, combination thereof.

### ADDITIONAL ASPECTS OF THE PRESENT DISCLOSURE

The following aspects of the disclosure are exemplary only and not intended to limit the scope of the disclosure.

1. A machine learning based imaging method for imaging and classifying whether one or more physical and subject consumer goods are authentic or non-authentic, the machine learning based imaging method comprising: a) obtaining an image of a subject consumer good comprising a subject product specification; b) inputting the obtained image into a model, wherein the model is configured to classify the obtained image as authentic or non-authentic, wherein the model is constructed by a machine learning classifier, wherein the machine learning classifier is trained by a training dataset, wherein the training dataset comprises: (i) extracted images, from a plurality of different camera types, of an authentic product comprising an authentic product specification comparable with the subject product specification, wherein the authentic product specification comprises at least one steganographic feature having a length greater than 0.01 mm; and (ii) an associated class definition based on the steganographic feature; and c) outputting a classification output from the model indicating a likelihood that the image of the subject consumer good is authentic or non-authentic.

2. The machine learning based imaging method of aspect 1, wherein the plurality of different camera types comprises at least three different camera types.

3. The machine learning based imaging method as in any one of aspects 1-2 further comprising augmenting the extracted images of the authentic product with at least one of geometric distortion or color distortion, and preferably with both geometric distortion and color distortion.

4. The machine learning based imaging method as in any one of aspects 1-3, wherein the at least one steganographic feature has a length from 0.02 mm to 20 mm.

5. The machine learning based imaging method as in any one of aspects 1-4, wherein the machine learning classifier is validated by a validating dataset, wherein the validating dataset comprises one or more images defining the at least one steganographic feature of the subject product specification.

6. The machine learning based imaging method as in any one of aspects 1-5, wherein the at least one steganographic feature is selected from one or more of: an isolated font style for a letter, an isolated font style for a number; an isolated location change of a text location, an isolated location change of a letter location, an isolated location change of a punctuation location.

7. The machine learning based imaging method as in any one of aspects 1-6, wherein the authentic product specification is selected from one or more of: a production code, a batch code, a brand name, a product line, a label, artwork, an ingredient list, or usage instructions.

8. The machine learning based imaging method as in any one of aspects 1-7, wherein the machine learning classifier is a convolutional neural network (CNN).

9. The machine learning based imaging method as in any one of aspects 1-8, wherein the training dataset is spatially manipulated before training the machine learning classifier.

10. The machine learning based imaging method as in any one of aspects 1-9, wherein the obtained image of the subject consumer good is spatially manipulated before being inputted into the model.

11. The machine learning based imaging method as in any one of aspects 1-10, wherein the training dataset further comprises further extracted images, from the plurality of different camera types, of a non-authentic product comprising a non-authentic product specification, wherein the non-authentic product specification is different from the at least one steganographic feature.

12. A machine learning based imaging method for imaging and classifying whether one or more physical and subject consumer goods are authentic or non-authentic, the machine learning based imaging method comprising: a) obtaining an image of a subject consumer good comprising a subject product specification; b) inputting the obtained image into a model, wherein the model is configured to classify the obtained image as authentic or non-authentic, wherein the model is constructed by a machine learning classifier, wherein the machine learning classifier is trained by a training dataset, wherein the training dataset comprises: (i) extracted images, from a plurality of different camera types, of an authentic product comprising an authentic product specification comparable with the subject product specification, wherein the authentic product specification comprises a Manufacturing Line Variable Printing Code; (ii) extracted images, from the plurality of different camera types, of non-authentic product comprising a non-authentic product specification comparable with the subject product specification, wherein the non-authentic product specification is different from the Manufacturing Line Variable Printing Code; and (iii) an associated class definition based on the Manufacturing Line Variable Printing Code; and c) outputting a classification output from the model indicating a likelihood that the image of the subject consumer good is authentic or non-authentic.

13. The machine learning based imaging method of aspect 12, wherein the plurality of different camera types comprises at least three different camera types.

14. The machine learning based imaging method as in any one of aspects 12-13, further comprising augmenting the extracted images of the authentic product with at least one of geometric distortion or color distortion.

15. The machine learning based imaging method as in any one of aspects 12-14, wherein the Manufacturing Line Variable Printing Code comprises one or more of: one or more alphanumeric characters, one or more non-alphanumeric characters, one or more non-alphanumeric characters comprising a pattern box, or one or more non-alphanumeric characters comprising a dotted column.

16. The machine learning based imaging method as in any one of aspects 12-15, wherein Manufacturing Line Variable Printing Code is printed or affixed to the subject consumer good by one or more of: a continuous ink-jet printer, an embossing, a laser etching, thermal transferring, or hot waxing.

17. The machine learning based imaging method as in any one of aspects 12-16, wherein training dataset comprises annotations that annotate the Manufacturing Line Variable Printing Code.

18. The machine learning based imaging method of aspect 5, wherein the training dataset comprises annotations annotating the at least one steganographic feature.

19. The machine learning based imaging method of aspect 1, wherein the at least one steganographic feature is generated by computing instructions configured for execution on a processor, that when executed caused the processor to automatically generate the steganographic feature based on one or more steganographic feature types.

20. The machine learning based imaging method of aspect 1, wherein the at least one steganographic feature is affixed on the subject consumer good during or after manufacture of the subject consumer good.

21. A tangible, non-transitory computer-readable medium storing instructions for imaging and classifying whether one or more physical and subject consumer goods are authentic or non-authentic, that when executed by one or more processors cause the one or more processors to: a) obtain an image of a subject consumer good comprising a subject product specification; b) input the obtained image into a model, wherein the model is configured to classify the obtained image as authentic or non-authentic, wherein the model is constructed by a machine learning classifier, wherein the machine learning classifier is trained by a training dataset, wherein the training dataset comprises: (i) extracted images, from a plurality of different camera types, of an authentic product comprising an authentic product specification comparable with the subject product specification, wherein the authentic product specification comprises at least one steganographic feature having a length greater than 0.01 mm; and (ii) an associated class definition based on the steganographic feature; and c) output a classification output from the model indicating a likelihood that the image of the subject consumer good is authentic or non-authentic.

22. A machine learning based imaging system configured to image and classify whether one or more physical and subject consumer goods are authentic or non-authentic, the machine learning based imaging system comprising: a server comprising a processor and a memory, the memory storing a model; and a software application (app) configured to execute on a mobile device comprising a mobile processor and a mobile memory, the software app communicatively coupled to the server via a computer network, wherein the server comprises computing instructions configured for execution on the processor, and that when executed by the processor causes the processor to: a) obtain an image of a subject consumer good comprising a subject product specification, the image captured by the mobile device; b) input the obtained image into the model, wherein the model is configured to classify the obtained image as authentic or non-authentic, wherein the model is constructed by a machine learning classifier, wherein the machine learning classifier is trained by a training dataset, wherein the training dataset comprises: (i) extracted images, from a plurality of different camera types, of an authentic product comprising an authentic product specification comparable with the subject product specification, wherein the authentic product specification comprises at least one steganographic feature having a length greater than 0.01 mm; and (ii) an associated class definition based on the steganographic feature; c) output a classification output from the model indicating a likelihood that the image of the subject consumer good is authentic or non-authentic; and d) transfer the classification output to the software application for display or use by the mobile device.

### ADDITIONAL CONSIDERATIONS

While embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

In addition, although the disclosure herein sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

This detailed description is to be construed as exemplary only and does not describe every possible embodiment, as describing every possible embodiment would be impractical, if not impossible. A person of ordinary skill in the art may implement numerous alternate embodiments, using either current technology or technology developed after the filing date of this application.

Those of ordinary skill in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A machine learning based imaging method for imaging and classifying whether one or more physical and subject consumer goods are authentic or non-authentic, the machine learning based imaging method comprising:
a) obtaining an image of a subject consumer good comprising a subject product specification;
b) inputting the obtained image into a model,
wherein the model is configured to classify the obtained image as authentic or non-authentic,
wherein the model is constructed by a machine learning classifier,
wherein the machine learning classifier is trained by a training dataset,
wherein the training dataset comprises: (i) extracted images, from a plurality of different camera types, of an authentic product comprising an authentic product specification comparable with the subject product specification, wherein the authentic product specification comprises at least one steganographic feature having a length greater than 0.01 mm; and (ii) an associated class definition based on the steganographic feature; and
c) outputting a classification output from the model indicating a likelihood that the image of the subject consumer good is authentic or non-authentic.

2. The machine learning based imaging method of claim 1, wherein the plurality of different camera types comprises at least three different camera types.

3. The machine learning based imaging method of claim 1 further comprising augmenting the extracted images of the authentic product with at least one of geometric distortion or color distortion.

4. The machine learning based imaging method of claim 1, wherein the at least one steganographic feature has a length from 0.02 mm to 20 mm.

5. The machine learning based imaging method of claim 1, wherein the machine learning classifier is validated by a validating dataset, wherein the validating dataset comprises one or more images defining the at least one steganographic feature of the subject product specification.

6. The machine learning based imaging method of claim 1, wherein the at least one steganographic feature is selected from one or more of: an isolated font style for a letter, an isolated font style for a number; an isolated location change of a text location, an isolated location change of a letter location, an isolated location change of a punctuation location.

7. The machine learning based imaging method of claim 1, wherein the authentic product specification is selected from one or more of: a production code, a batch code, a brand name, a product line, a label, artwork, an ingredient list, or usage instructions.

8. The machine learning based imaging method of claim 1, wherein the machine learning classifier is a convolutional neural network (CNN).

9. The machine learning based imaging method of claim 1, wherein the training dataset is spatially manipulated before training the machine learning classifier.

10. The machine learning based imaging method of claim 1, wherein the obtained image of the subject consumer good is spatially manipulated before being inputted into the model.

11. The machine learning based imaging method of claim 1, wherein the training dataset further comprises further extracted images, from the plurality of different camera types, of a non-authentic product comprising a non-authentic product specification, wherein the non-authentic product specification is different from the at least one steganographic feature.

12. A machine learning based imaging method for imaging and classifying whether one or more physical and subject consumer goods are authentic or non-authentic, the machine learning based imaging method comprising:
a) obtaining an image of a subject consumer good comprising a subject product specification;
b) inputting the obtained image into a model,
wherein the model is configured to classify the obtained image as authentic or non-authentic,
wherein the model is constructed by a machine learning classifier,
wherein the machine learning classifier is trained by a training dataset,
wherein the training dataset comprises: (i) extracted images, from a plurality of different camera types, of an authentic product comprising an authentic product specification comparable with the subject product specification, wherein the authentic product specification comprises a Manufacturing Line Variable Printing Code; (ii) extracted images, from the plurality of different camera types, of non-authentic product comprising a non-authentic product specification comparable with the subject product specification, wherein the non-authentic product specification is different from the Manufacturing Line Variable Printing Code; and (iii) an associated class definition based on the Manufacturing Line Variable Printing Code; and
c) outputting a classification output from the model indicating a likelihood that the image of the subject consumer good is authentic or non-authentic.

13. The machine learning based imaging method of claim 12, wherein the plurality of different camera types comprises at least three different camera types.

14. The machine learning based imaging method of claim 12, further comprising augmenting the extracted images of the authentic product with at least one of geometric distortion or color distortion.

15. The machine learning based imaging method of claim 12, wherein the Manufacturing Line Variable Printing Code comprises one or more of: one or more alphanumeric characters, one or more non-alphanumeric characters, one or more non-alphanumeric characters comprising a pattern box, or one or more non-alphanumeric characters comprising a dotted column.

16. The machine learning based imaging method of claim 12, wherein Manufacturing Line Variable Printing Code is printed or affixed to the subject consumer good by one or more of: a continuous ink-jet printer, an embossing, a laser etching, thermal transferring, or hot waxing.

17. The machine learning based imaging method of claim 12, wherein training dataset comprises annotations that annotate the Manufacturing Line Variable Printing Code.

18. The machine learning based imaging method of claim 5, wherein the training dataset comprises annotations annotating the at least one steganographic feature.

19. The machine learning based imaging method of claim 1, wherein the at least one steganographic feature is generated by computing instructions configured for execution on a processor, that when executed caused the processor to automatically generate the steganographic feature based on one or more steganographic feature types.

20. The machine learning based imaging method of claim 1, wherein the at least one steganographic feature is affixed on the subject consumer good during or after manufacture of the subject consumer good.

21. A tangible, non-transitory computer-readable medium storing instructions for imaging and classifying whether one or more physical and subject consumer goods are authentic or non-authentic, that when executed by one or more processors cause the one or more processors to:
a) obtain an image of a subject consumer good comprising a subject product specification;
b) input the obtained image into a model,
wherein the model is configured to classify the obtained image as authentic or non-authentic,
wherein the model is constructed by a machine learning classifier,
wherein the machine learning classifier is trained by a training dataset,
wherein the training dataset comprises: (i) extracted images, from a plurality of different camera types, of an authentic product comprising an authentic product specification comparable with the subject product specification, wherein the authentic product specification comprises at least one steganographic feature having a length greater than 0.01 mm; and (ii) an associated class definition based on the steganographic feature; and
c) output a classification output from the model indicating a likelihood that the image of the subject consumer good is authentic or non-authentic.

22. A machine learning based imaging system configured to image and classify whether one or more physical and subject consumer goods are authentic or non-authentic, the machine learning based imaging system comprising:
a server comprising a processor and a memory, the memory storing a model; and
a software application (app) configured to execute on a mobile device comprising a mobile processor and a mobile memory, the software app communicatively coupled to the server via a computer network,
wherein the server comprises computing instructions configured for execution on the processor, and that when executed by the processor causes the processor to:
a) obtain an image of a subject consumer good comprising a subject product specification, the image captured by the mobile device;
b) input the obtained image into the model,
wherein the model is configured to classify the obtained image as authentic or non-authentic,
wherein the model is constructed by a machine learning classifier,
wherein the machine learning classifier is trained by a training dataset,
wherein the training dataset comprises: (i) extracted images, from a plurality of different camera types, of an authentic product comprising an authentic product specification comparable with the subject product specification, wherein the authentic product specification comprises at least one steganographic feature having a length greater than 0.01 mm; and (ii) an associated class definition based on the steganographic feature;
c) output a classification output from the model indicating a likelihood that the image of the subject consumer good is authentic or non-authentic; and
d) transfer the classification output to the software application for display or use by the mobile device.
